(19) United States
(12) Patent Application Publication
(10) Pub. No.: US 2011/0039689 A1
(43) Pub. Date: Feb. 17, 2011

(54) SHAPED CATALYST BODY

(76) Inventors: Arno Tissler, Tegernheim (DE); Hans-Christoph Schwarzer, Hohenkirchen-Siegertsbrunn (DE); Roderik Althoff, Rosenheim (DE)

Correspondence Address: Florek & Endres PLLC, 1156 Avenue of the Americas, Suite 600, New York, NY, 10036, US

(21) Appl. No.: 12/596,278

(22) PCT Filed: Apr. 21, 2008
(86) PCT No.: PCT/EP08/03194

§ 371 Date: Nov. 4, 2010

(30) Foreign Application Priority Data
Apr. 19, 2007 (DE) 2007 018 612.8

(51) Int. Cl. B01J 35/00; B01J 21/06; B01J 21/04; B01J 21/08; B01J 21/10; B01J 29/04; B01J 23/36; B01J 23/46; B01J 23/44; B01J 23/42; B01J 23/745; B01J 23/32; B01J 23/72; B01J 23/50; B01J 23/52

(52) U.S. Cl. 502/74; 502/100; 502/349; 502/355; 502/232; 502/251; 502/300; 502/60; 502/79; 502/325; 502/339; 502/338; 502/324; 502/345; 502/347; 502/344

(57) ABSTRACT

The present invention relates to a shaped catalyst body comprising a core and a first catalytically active layer arranged on sections of the core, characterized in that the total density of the core is greater than the total density of the catalytically active layer. The invention further relates to the use of said shaped catalyst body as an oxidation catalyst in the cleaning of exhaust gases or for reducing and decomposing nitrogen oxides and nitrous oxide.

The present invention relates to a shaped catalyst body and the use of the shaped catalyst body, in particular for the reduction of nitrogen oxides and nitrous oxide in stationary systems.

Currently, bulk catalysts made from full extrudates which usually contain an iron-containing catalyst are used in fixed or stationary systems for the reduction of nitrous oxide and nitrogen oxide emissions (NO_{X} emissions).

In addition, so-called “monoliths” coated with TiO₂/WO₃/V₂O₅ are known as catalyst bodies for the reduction of NO_{X} emissions in the field of waste gas treatment for SCR catalysts (SCR=selective catalytic reduction).

The use of these extrudates is limited by their physical properties because, when used in a fixed bed, only low rates of gas flow towards them are possible if the whirling up of the catalyst bed and thus damage by abrasion to the shaped catalyst body during operation are to be prevented.

Another important factor is the residence time, i.e. the time that the substance system spends in a reactor. Usually not all the simultaneously introduced components of an incoming fluid stream remain in the reactor area for the same length of time. A greater or less degree of back-mixing of the fluid elements usually occurs. As a result, the particles that have entered the reactor display a residence time spectrum at the outlet.

In solid-state catalysis it is desirable that the residence time spread be as small as possible, because an excessively short or long residence of part of the mixture can lead to undesired properties of the product or adversely affect the overall catalytic effect.

The physical properties of extrudates influence the maximum permitted rate of flow, i.e. also the residence time, wherein the latter increases as the particle size of the extrudates decreases because particle inertia is avoided.

This was investigated for example in the dissertation by J. Ham (Chemnitz University, 2003) “Zur Berechnung der Verweilzeitverteilung von Partikeln”.

It is known that when a fluid flows through a fixed bed the pressure loss increases in proportion to the rate of flow. Only at the incipient fluidization point is the bed material carried by the fluid stream, with the result that the pressure loss then remains constant.

A so-called Reh diagram (Chem. Ing. Tech. 49, 10 et seq., H 1977) is used for evaluation.

The predetermination of the rate of flow in connection with the inertia of the particles makes specific demands on the technical configuration of a chemical system in which the catalyst is used. In particular factors connected to the relative velocity, such as the so-called terminal falling velocity, must also be taken into account here.

This is expressed by the so-called omega number Q which contains the terminal falling velocity and physical characteristics of the components used and is a function of the Reynolds number.

The omega number is also known as the Ljaschenko number Lj.

A further factor to be taken into account is the so-called Archimedes number Ar which contains the particle diameter and the physical characteristics and which is related to the omega number, wherein every point in the resulting diagram can be allocated a Reynolds number, wherein the respective value can be calculated for a given particle diameter or a terminal falling velocity and via it the valid Reynolds number determined, with the result that the appropriate rate of flow can be calculated for every catalyst system or shaped catalyst body system.

Further factors are the surface against which flow is directed, the supply and removal of heat, and the avoidance of vibrations, because for example shaped catalyst bodies experience a change in their bed weight as a result of mechanical stresses in the bed due to thermal expansion during heating/cooling, which can result in damage to the shaped catalyst body.

In general, the greater the particle inertia the greater the permitted rate of flow.

The Archimedes number is a dimensionless value which contains the inertia parameters and characterizes the particle inertia.

Included in particular in the Archimedes number is the diameter of a spherical body which experiences the same resisting force for the same flow and is thus a characteristic of the effective size of the flow towards a shaped catalyst body. The Archimedes number also includes the density difference between the total density of the whole catalyst and the gas density.

The object of the present invention was therefore to provide a shaped catalyst body which has as small as possible an extrudate particle size in order to make possible an acceleration of the substance transport, i.e. a lower residence time, by increasing its outer surface and yet simultaneously has a sufficient particle inertia to make higher rates of flow possible during the catalysis reaction.

This object is achieved by providing a shaped catalyst body which has a core and a first catalytically active layer arranged on sections of the core, wherein the total density of the core is greater than the total density of the catalytically active layer.

The total density denotes the density of the material taking into account its internal porosity and is defined as the mass (or weight) of the core/shaped body divided by the volume of its outer geometric shape.

It was surprisingly found for example that, when reacting nitrous oxide and nitrogen oxides, faster reaction times and thus a shorter residence time and a high rate of flow are obtained if a shaped catalyst body according to the invention is used in the bed.

The higher total density of the core of the shaped catalyst body, which is usually much higher than the density of the porous full extrudates used to date, substantially increases the particle inertia and thus makes possible a higher rate of flow during the reaction.

It is quite particularly preferred if the ratio of the total density of the core to the total density of the catalytically active layer is in the range of 2:1 to 10:1, quite particularly preferably in the range of 3:1 to 5:1. This also makes possible a wide variation of the materials of the core, with the result that a plurality of possible support materials can be used for the core.

It is preferred that the thermal conductivity of the core is greater than that of the catalytically active layer. Quite particularly preferably the ratio of the thermal conductivity of the core to the thermal conductivity of the catalytically active layer is greater than 10:1, and more preferably 100:1.

As a result of the increased thermal conductivity of the core compared with the first catalytically active layer a more even temperature distribution is achieved in the fixed bed and consequently the total conversion of the catalytic reaction is higher. Moreover a better supply and removal of heat to and from the fixed bed is possible if it takes place over a bed.

It is likewise preferred that the specific heat capacity of the core is higher than that of the first catalytically active layer, as fluctuations in temperature can thereby be lessened and there is a low thermal aging of the shaped catalyst body. In the preferred embodiments of the present invention the thermal expansion of the shaped catalyst body is approximately the same as that of the reactor housing, as a result of which the mechanical stress on the shaped catalyst bodies in the event of fluctuations in temperature is significantly reduced.

The core has a greater mechanical strength, with the result that a longer life of the shaped catalyst body according to the invention is also achieved over a longer operating period, as the shaped catalyst bodies do not break or split as quickly even during delivery or in operation due to mechanical stress.

As a result of using a core which is more solid than the catalytically active layer, the catalytically active layer can have a higher porosity than the core, as the mechanical strength requirements to be met by the applied catalytically active layer are less. Activity can thereby be increased. An increase in the porosity of the catalytically active layer leads to a reduction of the total density or the inertia of the shaped catalyst body and thus also to a reduction of the permitted rate of flow.

In particularly preferred embodiment examples, the catalytically active first layer surrounds the whole core, with the result that the catalytically active surface of the shaped body is also increased accordingly compared with a catalytically active first layer arranged on sections of the core. The thickness of the catalytically active layer is preferably 5 to 1,000 μm, particularly preferably 10 to 800 μm.

Preferred materials for the core are for example materials such as ZrO₂, Al₂O₃, SiO₂, magnesium silicates, ceramics such as mullite, cordierite, carbides, silicates and oxides of early transition metals, metals, metal alloys and glass. The use of these materials also makes possible the use of more complex geometric structures for shaped catalyst bodies according to the invention. It is furthermore preferred that the material of the core is not a zeolite or a zeolitic material. The core is thus preferably free from zeolites or zeolitic materials.

Shaped catalyst bodies usually consist of relatively simple geometries, as to date almost exclusively full extrudates have been used. Typical shaped bodies are present for example in the form of spheres, rings, cylinders, perforated cylinders, trilobates and cones etc.

However, open-pored foam structures and so-called monoliths, having channels running largely parallel to one another which can be connected to one another, made of a metal, a metal alloy, ceramic such as for example silicon carbide, Al₂O₃, mullite, cordierite or aluminium titanate can also be used as core.

Further preferred bodies for the core are made for example from sheet metal or sheet-metal strips with a thickness of typically less than 1 mm, produced from any metal or a metal alloy, such as for example foils or metal fabric which can be produced by extrusion, winding, stacking or folding. Within the meaning of this invention, the term core is also to be used here.

Temperature-resistant alloys of iron, chromium and aluminium are customarily used in the field of the purification of waste gases.

In further preferred developments of the present invention, the first catalytically active layer can consist of a single homogeneous layer or also several layers. The latter can also be applied in one step or in several individual steps. Almost any sequence of layers is possible, the only important point being that a layer contains a catalytically active component.

In further preferred embodiments, yet another catalytically active layer and/or a layer containing a promoter component is applied to the first catalytically active layer, which makes it possible for a plurality of different catalysis reactions to be carried out using the shaped catalyst body according to the invention, such as for example catalytic reduction and oxidation reactions.

In preferred embodiments, the catalytically active second layer contains a metal or a metal oxide from the group consisting of rhenium, ruthenium, iron, manganese, osmium, rhodium, iridium, palladium, platinum, copper, silver and gold and also their mixtures and alloys.

The catalytically active first layer preferably contains a so-called metal-exchanged zeolite in which some of the lattice sites in the aluminium silicate of the zeolite are replaced by or exchanged for metal atoms or metal oxides. However, it is also possible that the metals form only active centres built up from one or more metal atoms inside the pores of the zeolite.

Preferred metals for the metal exchange or for the insertion of such metal species are the elements of the 1st, 3rd, 4th, 5th and 8th sub-groups, preferably Fe, Cu, Co, Ag, Cr, V, W, Ni, quite particularly preferably Fe, Cu, Co, Ag or their oxides and mixtures thereof.

The metal exchange can usually take place using methods known per se such as for example aqueous ion exchange, impregnating incipient wetness methods or by solid-state exchange.

In the first case, aqueous iron salt solutions of chlorides, nitrates or sulphates of iron are used, in the latter case solid iron compounds such as for example iron sulphate or iron chloride are used.

The thus-inserted metal atoms or metal oxides are located either in the zeolitic cavities which are connected to each other for example by narrower pores, wherein the maximum pore size available in each case limits the spatial accumulation of metal atoms.

The metals can be present both in metal form and in the form of their oxides or mixed oxides.

The meaning of zeolite in the present case is that defined within the nomenclature of Meyer et al, “Atlas of Zeolite Structure Types”, Edition Butterworth-Heinemann, 1996, reference to the full content of which is made here.

Materials similar to zeolite can naturally also be used according to the invention.

Typical materials are silicates, alumosilicates, aluminophosphates, metal aluminophosphates, phosphosilicates, titanosilicates or silicoaluminophosphates.

Particularly preferred topological structures of zeolites that can be used according to the invention are AFI, AEL, BEA, CHA, EOU, FAU, FER, KFI, LTL, MAZ, MFI, MOR, REI, OFF, TON.

The zeolite materials can be present both in their sodium and in their ammonium or H form.

Further topological structures of mesoporous zeolite materials are for example the so-called M41S materials which are disclosed in U.S. Pat. No. 5,089,684 and in U.S. Pat. No. 5,102,643 and can likewise be used according to the invention.

Preferred here are for example the topological structures denoted MCM41 and MCM48. The former are particularly more preferred, as they have a hexagonal arrangement of the mesopores with uniform size.

In order to increase catalytic activity, it can be provided in a preferred development of the shaped body according to the invention that the catalytically active first layer containing a zeolite has a BET surface area of 10-500 m²/g, particularly preferably 20-300 m²/g and quite particularly preferably 40-150 m²/g. Thus good accessibility of the catalysis educts to the catalytically active centres is made possible. The BET surface area is usually determined by adsorption of nitrogen according to DIN66132.

The integral pore volume of the first catalytically active layer can be determined for example according to DIN66133 by means of Hg porosimetry and is preferably greater than 100 mm³/g, preferably greater than 180 mm³/g, even more preferably greater than 200 mm³/g and quite particularly preferably greater than 400 mm³/g.

In quite particularly preferred embodiments the first catalytically active layer is applied to the core which is present for example in the form of a fleece, a so-called monolith or a porous foam.

The catalytically active layer is usually applied in the form of a so-called washcoat, i.e. an aqueous suspension, for example by dipping, spraying, etc, wherein the average particle size of the catalytically active component is less than 10 μm, preferably less than 3 μm.

Dopings, for example by means of alkaline-earth oxides or early transition metal oxides and rare earth oxides, are likewise possible.

After application by means of methods known per se, the fixing of the washcoat suspension on the support is carried out by calcining usually at temperatures of 300-800° C.

The other components present in the washcoat can likewise be catalytically active and preferably bring about synergistic effects.

The shaped body according to the invention is used in numerous catalytic reactions which proceed in a fixed bed, for example as oxidation catalyst or for the reduction or decomposition of nitrogen oxides and nitrous oxide in stationary systems.

The present invention is explained below in more detail with reference to a figure, the explanation of which is to be understood as non-limiting.

There is shown in

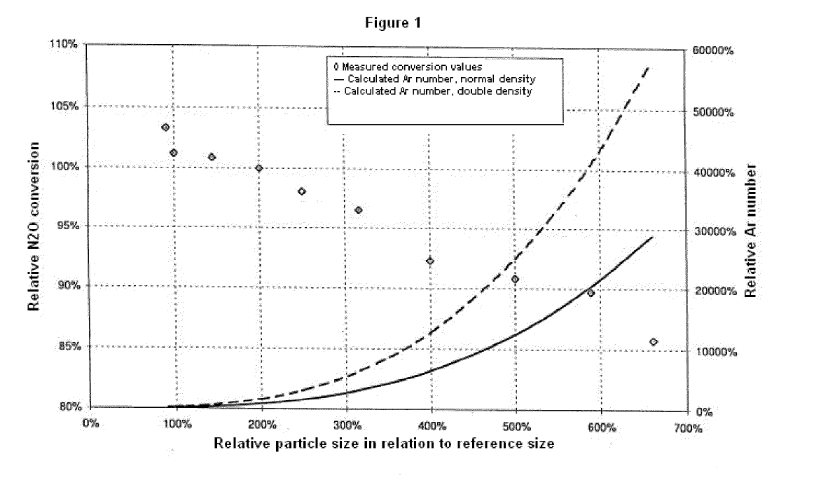

FIG. 1 the influence of the particle size on the measured conversion using the example of nitrous oxide conversion and the relationship between the Ar number and the particle size for shaped catalyst bodies of two different densities, shown as a relative change compared with a reference catalyst.

As FIG. 1 shows, the measured conversion falls as the particle size increases, whereas the particle inertia, expressed by the Ar number, and thus the maximum permitted rate of flow, increases. FIG. 1 also shows the influence of density. By doubling the core density, the particle size can be significantly reduced for the same Ar number, and a significant increase in conversion thereby achieved.

1. A shaped catalyst body comprising a core and a first catalytically active layer arranged on sections of the core, characterized in that the total density of the core is greater than the total density of the catalytically active layer.

2. The shaped catalyst body according to claim 1, characterized in that the ratio of the total density of the core to the total density of the catalytically active layer is in the range of 2:1 to 10:1.

3. The shaped catalyst body according to claim 2, characterized in that the ratio is 3:1 to 5:1.

4. The shaped catalyst body according to claim 2, characterized in that the thermal conductivity of the core is greater than the thermal conductivity of the first catalytically active layer.

5. The shaped catalyst body according to claim 1, characterized in that the thickness of the catalytically active layer is 5-1,000 μm.

6. The shaped catalyst body according to claim 5, characterized in that the first catalytically active layer completely surrounds the whole core.

7. The shaped catalyst body according to claim 5, characterized in that the core of the shaped catalyst body consists of a material which is selected from the group consisting of ZrO₂, Al₂O₃, SiO₂, magnesium silicates, metals, metal alloys, ceramics, glass and mixtures thereof.

8. The shaped catalyst body according to claim 7, characterized in that the core has a three-dimensional support structure.

9. The shaped catalyst body according to claim 8, characterized in that the three-dimensional support structure is a honeycomb, a monolith, a foam or a fleece.

10. The shaped catalyst body according to claim 7, characterized in that a second layer containing a promoter component or a further catalytically active component is arranged on sections of the first catalytically active layer.

11. The shaped catalyst body according to claim 1, characterized in that the first catalytically active layer contains a metal-exchanged zeolite.

12. The shaped catalyst body according to claim 11, characterized in that the zeolite is exchanged with a metal selected from the group consisting of Fe, Cu, Co, Ag, Cr, V, W, Ni or mixtures thereof.

13. The shaped catalyst body according to claim 12, characterized in that the metal-exchanged zeolite is an iron-exchanged zeolite.

14. The shaped catalyst body according to claim 12, characterized in that the zeolite is selected from the group consisting of the structure types: AFI, AEL, BEA, CHA, EUO, FAU, FER, KFI, LTL, MAZ, MOR, MEL, MTW, OFF, TON and MFI.

15. The shaped catalyst body according to claim 1, characterized in that the second catalytically active layer contains a metal or metal oxide as catalytically active component selected from the group consisting of rhenium, ruthenium, osmium, rhodium, iridium, palladium, platinum, iron, manganese, copper, silver, gold or their oxides or mixtures thereof

16. Use of a shaped catalyst body according to claim 1 as an oxidation catalyst.

17. Use of a shaped catalyst body according to claim 1 as a catalyst in the purification of waste gases.
